(19) United States
(12) Patent Application Publication
(10) Pub. No.: US 2012/0179435 A1
(43) Pub. Date: Jul. 12, 2012

(54) Method For Determining A Power Capability For A Battery

(75) Inventors: Jing Song, Novi, MI (US); Richard Dyche Anderson, Plymouth, MI (US); Yonghua Li, Ann Arbor, MI (US); Yanan Zhao, Ann Arbor, MI (US); Xiao Guang Yang, Northville, MI (US)

(73) Assignee: FORD GLOBAL TECHNOLOGIES, LLC, Dearborn, MI (US)

(21) Appl. No.: 12/987,190

(22) Filed: Jan. 10, 2011

(51) Int. Cl. G06F 17/10

(52) U.S. Cl. 703/2

(57) ABSTRACT

A method for determining a power capability for a battery includes the step of defining at least one equation based on a circuit model for the behavior of the battery. The equation includes a plurality of battery parameters, including a battery current. The value of at least one of the battery parameters is measured, and the battery current is solved-for from the at least one equation. A limiting battery current is defined based at least in part on the battery current. A limiting battery voltage is determined, and the power capability of the battery is determined based on the limiting battery current and the limiting battery voltage.

### TECHNICAL FIELD

The present invention relates to a method for determining a power capability for a battery.

### BACKGROUND

In any vehicle with a traction battery system, such as a hybrid electric vehicle (HEV), plug-in HEV (PHEV) or battery electric vehicle (BEV), vehicle controls need to know how much power the battery can provide (discharge) or take in (charge) in order to meet the driver demand and to optimize the energy usage. A battery management system may, for example, calculate the battery power limit based on battery age, temperature, and state of charge. These limits can then be provided to various other vehicle controls, for example, through a vehicle system controller (VSC) so that the information can be used by systems that may draw power from or provide power to the fraction battery.

In order to calculate the battery power limits, a battery management system may determine the battery's inherent power capability. The capability of a new battery can be measured in the lab; however, it can be very difficult to determine that capability for a battery on-board in a vehicle as it ages. Battery power capability can depend on a number of factors, such as battery usage history, which includes battery age, charge and discharge history, storage history, and the environment where the battery is used and stored. The power capability of a battery varies with the battery states, such as state of charge (SOC), temperature, etc. Complicating matters further, the power capability of a battery is often not identical among the cells making up a battery pack. This can be due to manufacturing variations, or, for example, a different temperature history depending on where in the pack the cell is located.

For the reasons discussed above, estimating a battery power capability through the life of a battery can be a difficult process that leads to inaccurate results. Over-estimating the battery power capability may allow the electrical loads to attempt to draw more power from the battery than it is capable of providing. This can lead to battery damage or reduced usable battery life. Under-estimating the power capability of a battery can unnecessarily limit its use. In the case of a traction battery in a vehicle, an inaccurately low estimate of the battery power capability can lead to reduced electric drive mode, and increased engine drive mode. This can limit vehicle performance and degrade the fuel economy.

In addition to the foregoing, when a battery controller, such as a battery control module, is replaced, the battery power capability history can be lost. Similarly, if one or more new cells are installed in a battery, the battery power capability has to be reestablished. In either of these cases it is desirable to have the battery controls learn the battery power capability quickly and communicate this information to other vehicle controls. Thus, a need exists for a method for determining a battery power capability that provides accurate information, and which responds quickly to changing conditions so that the power capability information remains accurate.

### SUMMARY

Embodiments of the invention include a method for determining a power capability for a battery. The method includes the step of determining a circuit model for the behavior of the battery. At least one governing equation for the circuit model that includes a battery current is determined. The battery current is solved-for from the at least one governing equation. A limiting battery voltage is defined, and a limiting battery current is determined using the limiting battery voltage. The power capability of the battery is determined based on the limiting battery current and the limiting battery voltage.

Embodiments of the invention also include a method for determining a power capability for a battery that includes the step of generating at least one equation for a circuit model for the battery. A battery current is defined from the at least one equation, and a limiting battery current is determined based at least in part on the defined battery current. A limiting battery voltage is determined, and the power capability of the battery is determined based on the limiting battery current and the limiting battery voltage.

Embodiments of the invention also include a method for determining a power capability for a battery that includes the step of defining at least one equation based on a circuit model for the behavior of the battery. The at least one equation includes a plurality of battery parameters, including a battery current. A value of at least one of the battery parameters is measured, and the battery current is solved-for from the at least one equation. A limiting battery current is defined based at least in part on the battery current. A limiting battery voltage is determined, and the power capability of the battery is determined based on the limiting battery current and the limiting battery voltage.

### BRIEF DESCRIPTION OF THE DRAWINGS

FIG. 1 is a general circuit model that can be used to model the behavior of a battery in accordance with embodiments of the present invention;

FIG. 2 is a detailed version of the general circuit model illustrated in FIG. 1;

FIG. 3 is a graph that can be used with embodiments of the present invention, and illustrates the relationship between the open circuit voltage of a battery cell and its state of charge;

FIG. 4 is a flow chart illustrating embodiments of a method in accordance with the present invention;

FIG. 5 is a graph showing traces of a battery power capability calculated in accordance with embodiments of the present invention; and

FIG. 6 is a graph showing traces of a battery power capability determined in accordance embodiments of the present invention, where the power capability is calculated during a dynamic drive environment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

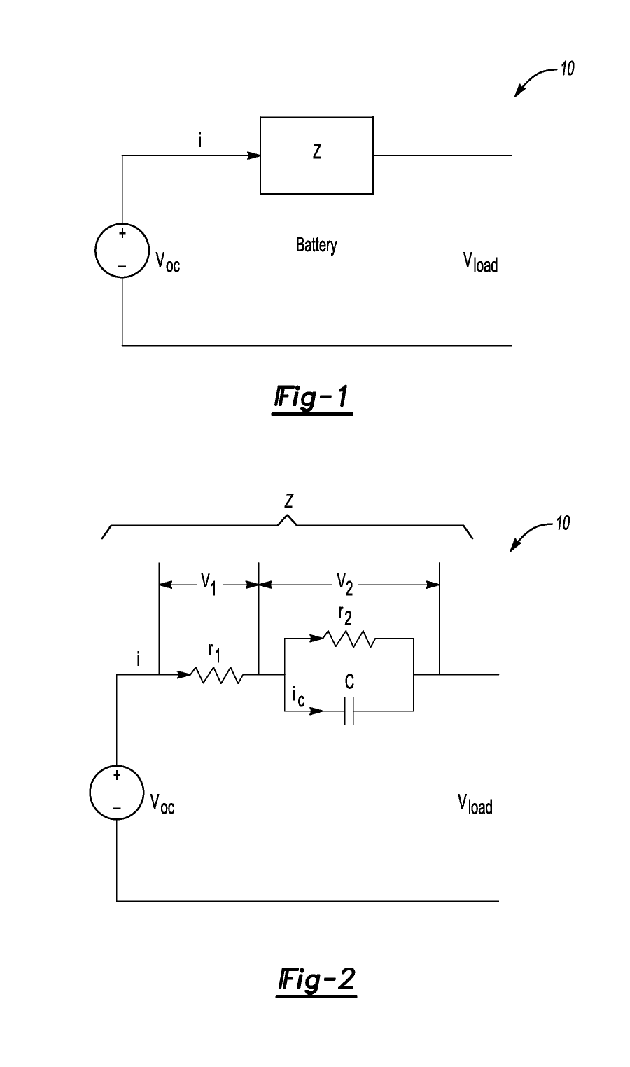

FIG. 1 shows a generalized circuit model 10 representing a battery and a battery load. Specified in the circuit model 10 is an open circuit voltage (v_{oc}), a battery current (i), a voltage load (v), and a generalized sub-circuit (Z). It is understood that the sub-circuit (Z) may contain a number of different electrical elements, such as resistors, capacitors, inductors and the like. As discussed in detail below, the purpose of the circuit 10 is to provide information regarding a battery that can be used to determine a power capability for the battery. Therefore, the circuit model 10 may more accurately represent the behavior of the battery if the sub-circuit (Z) contains a relatively large number of electrical components; however, with an increased number of components in the sub-circuit (Z) there is also an attendant increase in the complexity of the equations that govern the circuit model.

FIG. 2 shows an example of the circuit model 10 where the sub-circuit (Z) is made up of three electrical components, specifically, two resistors (r₁, r₂) and one capacitor (c). From the circuit model 10 shown in FIG. 2, a pair of governing equations can be written as follows:

$$\begin{matrix}{\dot{v}}_{2} = - \frac{1}{{r}_{2} c} {v}_{2} + \frac{1}{c} i & Eq . 1 \\ {v}_{oc} - v = {v}_{2} + {ir}_{1} & Eq . 2\end{matrix}$$

where:
v is a determined battery voltage,
v₂ is a voltage from the circuit model,

$${\dot{v}}_{2} = \frac{d {v}_{2}}{d t}$$

and is the time based differential of v₂,
v_{oc} is the open circuit voltage of the battery,
i is the battery current, and
r₁, r₂, c are two resistance values and a capacitance value, respectively, from the circuit model.

As seen above, the battery current (i), appears in each of Equations 1 and 2. Also included are other battery parameters, such as voltages (v), (v₂), and (v_{oc}). The battery current (i) is a determined value, which can be, for example, measured directly from the battery; this is also the case for the voltage (v).

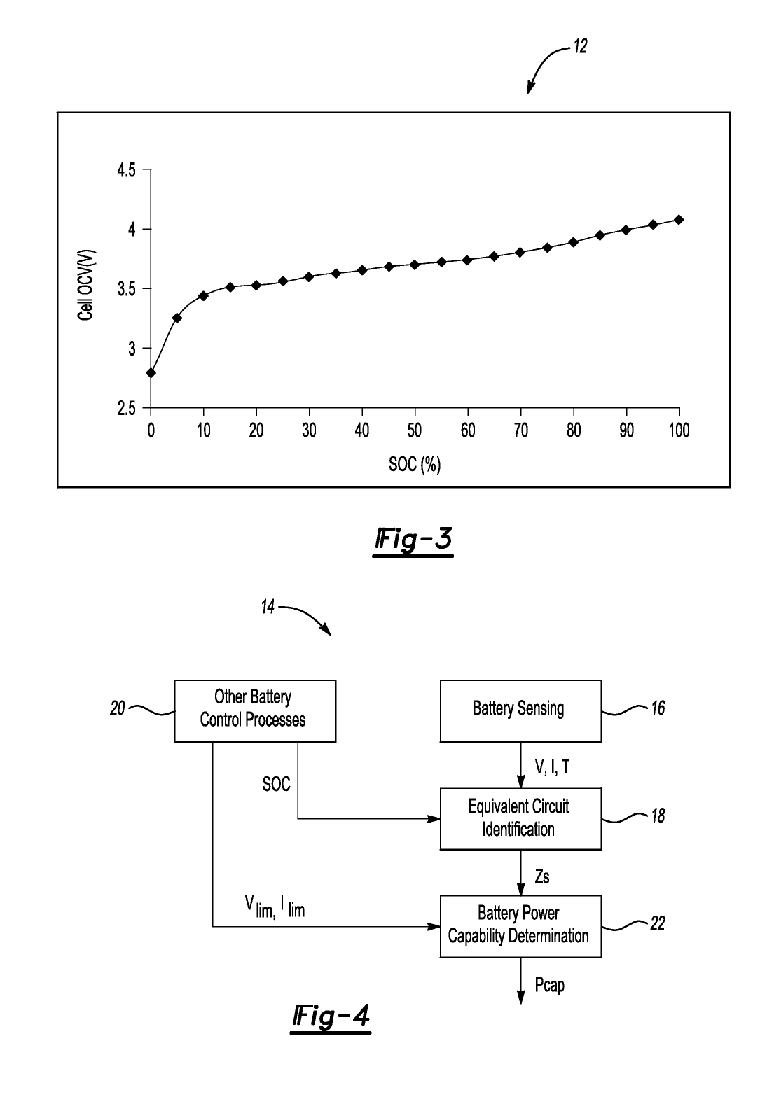

For any of the variables in these equations, there may be a number of different ways to determine them. For example, where the battery under consideration is a traction battery in an electric or hybrid electric vehicle, the battery current (i) and voltage (v) may be regularly measured at some predetermined frequency so that these values can be used by other vehicle control systems. In the case of an open circuit voltage for the battery (v_{oc}) the value can be directly measured when the vehicle is started before the electrical contactor is closed. When the vehicle is running, however, and the contactor is closed, the open circuit voltage (v_{oc}) must be estimated. FIG. 3 shows one way by which the v_{oc} for a battery can be estimated based on the battery SOC. The graph 12 shown in FIG. 3 illustrates a monotonic relationship between the battery v_{oc} and SOC for a lithium ion battery. Other types of batteries, having different battery chemistries, may exhibit similar relationships, or different relationship that are nonetheless known and can be used in a similar fashion to the graph 12 shown in FIG. 3.

There may be a number of ways to determine the v_{oc} from the battery SOC; the method that is used may depend, for example, on whether the SOC is known for the battery pack as a whole, or if the SOC is known for each of the individual battery cells. In the case where the SOC is known for each of the battery cells, Equation 3 as shown below can be used.

$${v}_{oc} = {\sum }_{i = 1}^{N} {v}_{oci} = {\sum }_{i = 1}^{N} f ( {SOC}_{i} ) \qquad Eq . 3$$

where: N is the number of battery cells in the battery pack.

Using the known SOC values for each battery cell, a corresponding v_{oc} value can be determined, for example, from a graph, such as the graph 12 shown in FIG. 3, from a lookup table or from some other known relationship between the v_{oc} and the SOC. Then, each of the calculated v_{oc} values for the individual battery cells can be summed to provide the total v_{oc} for the battery pack. In this model, it is assumed that the battery cells are connected in series, thereby making their voltages additive. Calculating the v_{oc} in this matter provides a very accurate estimate of the battery v_{oc}, which cannot be directly measured. By adding all of the values of the battery cell v_{oc}'s the weakest battery cells will lower the overall v_{oc} for the battery pack, ensuring that its value is not unrealistically high.

To the extent that the SOC for each battery cell is not known, another way to determine an v_{oc} for the battery pack is shown in Equations 4 and 5 below.

v_{oc}=N×v_{ocmin}=N×f(SOCₘᵢₙ) during discharge Eq. 4

v_{oc}=N×v_{ocmax}=N×f(SOCₘₐₓ) during charge Eq. 5

As shown in Equations 4 and 5, there are two different versions of the battery pack v_{oc}: one for battery discharge (Eq. 4), and another for battery charge (Eq. 5). The reason for this is that there are two different battery power capabilities, one associated with battery discharge and another associated with battery charge. Each of these battery power capabilities are limited by different values of the v_{oc}. For example, the discharge battery power capability is limited by the minimum v_{oc} for the battery pack; whereas, the charge battery power capability is limited by the maximum v_{oc} for the battery pack. Equations 4 and 5 can be used as an alternative to Equation 3 even if the SOC for each of the batteries cells is known. In such a case, the smallest battery cell SOC will be used in Equation 4, and the largest battery cell SOC used in Equation 5. This has the advantage of speed and ease of calculation, but this approach may be undesirably conservative.

One of the advantages of Equations 4 and 5 is that they can be utilized even if the individual SOC values for the battery cells are not known. Depending on the system in which the battery operates, the system designer or manufacturer may impose limits on how low the SOC for the battery is allowed to go before it is recharged. Similarly, limits may be imposed on how high the battery SOC is allowed to go before it stops accepting any further charge. These predetermined limiting values can be used in Equations 4 and 5 to determine a discharge v_{oc} and a charge v_{oc} for the battery being examined.

Although some of the variables occurring in Equations 1 and 2 such as (i) and (v) can be measured directly or estimated as described above, determination of other variables may require different means. For example, one way to determine values for at least some of the variables in Equations 1 and 2 is to apply a Kalman filter to the equations. One way that a Kalman filter can be applied is to consider the current (i) as the input, the voltage (v₂) as a state, and the term (v_{oc}−v) as the output. The circuit components (r₁), (r₂) and (c) are also treated as states to be identified. The basic Kalman filter can be extended to estimate not only the states but also simultaneously estimate the circuit components. Once the circuit components and other unknowns are identified, the power capability can be calculated based on operating limits of a battery voltage and current, and the current battery state.

The first order differential equation from Equations 1 and 2 can be solved to yield the following expression for the battery current (i).

$$i = \frac{( {v}_{oc} - v - {v}_{2} ( 0 ) {e}^{- {t}_{d} / ( {r}_{2} c )} )}{[ {r}_{1} + {r}_{2} ( 1 - {e}^{- {t}_{d} / ( {r}_{2} c )} ) ]} \qquad Eq . 6$$

where:
t_{d} is a predetermined time value,
v₂ (0) is the present value of v₂, and
e is the base of the natural logarithm.

In general, once the value for (i) from Equation 6 is determined, the battery power capability can be found. For example, it may be desirable to determine a limiting battery current that is at least partly based on Equation 6. Where it is desired to determine a discharge power capability for the battery, Equation 6 can be solved for a maximum value of (i), such as shown in Equation 7. As used in the equations, discharge current is defined as a positive (+) quantity, and charge current is defined as a negative (−) quantity.

$${i}_{max} = ( {t}_{d} , {v}_{min} ) = \frac{( {v}_{oc} - {v}_{min} - {v}_{2} ( 0 ) {e}^{- {t}_{d} / ( {r}_{2} c )} )}{[ {r}_{1} + {r}_{2} ( 1 - {e}^{- {t}_{d} / ( {r}_{2} c )} ) ]} \qquad Eq . 7$$

where:
the value of (t_{d}) is predetermined, and may be for example, between 1 sec. and 10 sec., and
vₘᵢₙ is a minimum operating voltage of the battery pack and may be considered a limiting battery voltage.

The time value (t_{d}) can be based on a number of factors such as the battery usage history and the usage of the load or loads attached to the battery, such as the vehicle itself in the case of a traction battery. The voltage (vₘᵢₙ) may be determined, for example, by a vehicle manufacturer or a battery manufacturer as the minimum voltage the battery is allowed to reach.

Rather than using the current value (iₘₐₓ) without further examination, embodiments of the present invention compare (iₘₐₓ) to a discharge limit current (i_{dchlim}) to determine if (iₘₐₓ) is less than or equal to (i_{dchlim}). The reason for this is that the discharge limit current (i_{dchlim}) may provide a boundary that is lower than (iₘₐₓ). Specifically, the physical characteristics of systems associated with the battery may not be able to receive the full current of (iₘₐₓ), for example, wiring associated with the battery or a fuse associated with a battery, may require a current that is lower than the calculated value of (iₘₐₓ). In such a case, the discharge limit current can be substituted for (iₘₐₓ). This produces Equation 8 as shown below.

$${i}_{dch lim} = \frac{( {v}_{oc} - {\overline{v}}_{dch} - {v}_{2} ( 0 ) {e}^{- {t}_{d} / ( {r}_{2} c )} )}{[ {r}_{1} + {r}_{2} ( 1 - {e}^{- {t}_{d} / ( {r}_{2} c )} ) ]} \qquad Eq . 8$$

As shown in Equation 8, the value of (vₘᵢₙ) that was in Equation 7 is now a discharge voltage ( v̅_{dch}). Unlike the minimum battery voltage (vₘᵢₙ) the discharge voltage ( v̅_{dch}) is not known and must be solved for. Fortunately, the discharge limit current (i_{dchlim}) is known and Equation 8 can be rearranged as shown below in Equation 9.

v̅_{dch}=v_{oc}−v₂(0)e^{-t}^{_{d}}^{/(r}^{₂}^{c)}−i_{dchlim}*[r₁+r₂(1−e^{-t}^{_{d}}^{/(r}^{₂}^{c)})] Eq. 9

Finally, the discharge power capability for the battery as a function of the time (t_{d}) can be determined as shown in Equation 10.

$${P}_{cap \_ dch} ( {t}_{d} ) = \{ \begin{matrix}{i}_{max} * {v}_{min} & if {i}_{max} \leq {i}_{dch lim} \\ {i}_{dch lim} * {\overline{v}}_{dch} & Otherwise\end{matrix} \qquad Eq . 10$$

In addition to determining a discharge power capability for a battery, embodiments of the present invention also provide a method for determining a charge power capability for the battery. For determining the charge power capability, a minimum value of the battery current (i) is used in conjunction with a minimum value of the battery voltage. Equation 6 can be used to solve for (iₘᵢₙ) as shown in Equation 11.

$${i}_{min} = ( {t}_{d} , {v}_{max} ) = \frac{( {v}_{oc} - {v}_{max} - {v}_{2} ( 0 ) {e}^{- {t}_{d} / ( {r}_{2} c )} )}{[ {r}_{1} + {r}_{2} ( 1 - {e}^{- {t}_{d} / ( {r}_{2} c )} ) ]} \leq 0 \qquad Eq . 11$$

where: vₘₐₓ is a maximum operating voltage for the battery.

If this was the end of the inquiry, Equation 11 could be solved for Eq. 10 and this value multiplied by (vₘₐₓ) to get the charge power capability. Just as on the discharge side, however, a limiting value for the current is determined. In this case, the value (iₘᵢₙ) is compared to a charge limit current to see which value is greater. In the case where (iₘᵢₙ) is greater than the charge limit current, the value of (iₘᵢₙ) will be used to determine the charge power capability. Conversely, if the charge limit current (i_{chlim}) is greater than (iₘᵢₙ), then this value will be used in determining the charge power capability. Similar to the discharge power capability analysis, Equation 12 is used to determine a charge voltage ( v̅_{ch}).

$${i}_{ch lim} = \frac{( {v}_{oc} - {\overline{v}}_{ch} - {v}_{2} ( 0 ) {e}^{- {t}_{d} / ( {r}_{2} c )} )}{[ {r}_{1} + {r}_{2} ( 1 - {e}^{- {t}_{d} / ( {r}_{2} c )} ) ]} \qquad Eq . 12$$

Because the value of (i_{chlim}) is known, Equation 12 can be rearranged to solve for the charge voltage—see Equation 13.

v̅_{ch}=v_{oc}−v₂(0)e^{-t}^{_{d}}^{/(r}^{₂}^{c)}−i_{chlim}*[r₁−r₂(1−e^{-t}^{_{d}}^{/(r}^{₂}^{c)})] Eq. 13

In summary, a limiting battery current can be defined as the greater of (iₘᵢₙ) and the charge limit current (i_{chlim}). Thus, the charge power capability for a battery can be written in accordance with Equation 14.

$${P}_{cap\_ch} ( {t}_{d} ) = \{ \begin{matrix}\vert {i}_{min} \vert * {v}_{max} & if {i}_{min} \geq {i}_{ch lim} \\ \vert {i}_{chlim} \vert * {\overline{v}}_{ch} & Otherwise\end{matrix} \qquad Eq . 14$$

FIG. 4 shows a flow chart 14 illustrating a method in accordance with embodiments of the present invention. At step 16, a number of battery parameters are measured, such as voltage (v), current (i) and temperature (T). Values for these parameters are passed to the equivalent circuit identification at step 18. Using the example from above, the voltage and current values will be used in Equation 2 along with application of the Kalman filter to solve for the battery current (i) shown is Equation 6.

In addition to the battery parameters determined at step 16, additional battery control processes can be determined at step 20, and values passed to the equivalent circuit identification at step 18, or, for example, step 22, where the battery power capability is determined. In the embodiment shown FIG. 4, the state of charge (SOC) is used by the equivalent circuit identification step 18, and in particular may be used to determine an open circuit voltage as described above. The discharge and charge current and voltage limits as indicated by (Vₗᵢₘ) and (Iₗᵢₘ) can be used in step 22 during the battery power capability determination, as described above. The value of Vₗᵢₘ may represent, for example, vₘᵢₙ or vₘₐₓ as described above, and likewise, Iₗᵢₘ may represent, for example, iₘᵢₙ or iₘₐₓ. The output from step 22 is the battery power capability, indicated by (P_{cap}), which can be a discharge or charge capability, as indicated by Eq's 10 and 14, respectively. Further, because the power capabilities as shown in Eq's 10 and 14 are time-based functions of t_{d}, multiple values of P_{cap} can be calculated for each of the discharge and charge power capabilities.

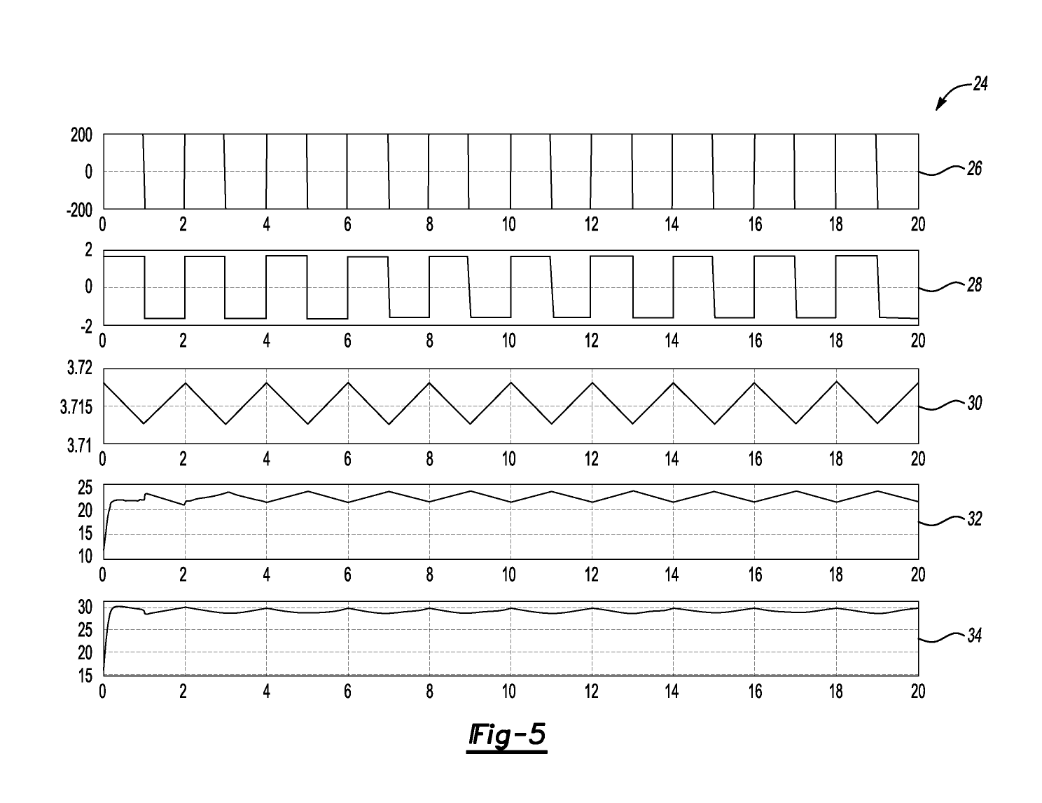

The power capability for a battery as determined by the present invention quickly reaches accurate values after the inputs are determined and the processing of the algorithms described above take place. FIG. 5 shows a graphical output 24 that includes a number of signals for a vehicle having a battery whose power capability is determined in accordance with the present invention. The top trace on the graph 24 shows current (i) as measured from the battery. The trace 28 shows cell voltage of the battery, which can also be a measured parameter. The open cell voltage is shown in trace 30, and as discussed above, can be measured prior to the contactor closing, or estimated, for example, from the battery SOC. Traces 32, 34 respectively show the charge power capability and the discharge capability for the battery. Initially, when the analysis is started, the error in the power capability is very high; however, in less than one second, the power capabilities reach an accurate value and remain stable over time.

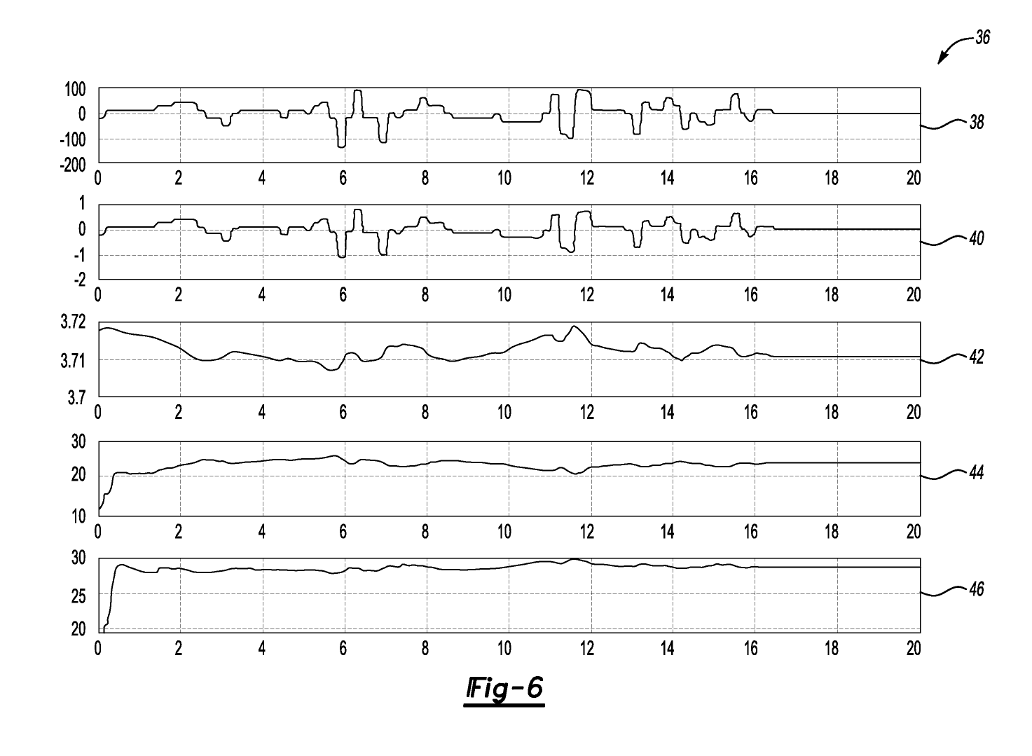

The graph 24 shown in FIG. 5 shows the power capabilities for a battery in a vehicle that is not in a dynamic drive cycle. Conversely, the graph 36 shown in FIG. 6 shows the output from an analysis on a battery that is in a vehicle engaged in a dynamic drive environment. Thus, the current, voltage, and open cell voltage, as indicated by traces 38, 40, 42, have much greater variability than their counterparts in FIG. 5. Even with the dynamic drive environment, the charge and discharge power capabilities of the battery as indicated by traces 44, 46 quickly reach an accurate level, and remain stable over time, at least within the variances expected by the changing drive environment.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for determining a power capability for a battery, comprising:
determining a circuit model for the behavior of the battery;
determining at least one governing equation for the circuit model that includes battery current;
solving the at least one governing equation for the battery current;
defining a limiting battery voltage;
determining a limiting battery current using the limiting battery voltage; and
determining the power capability of the battery based on the limiting battery current and the limiting battery voltage.

2. The method of claim 1, further comprising:
determining a maximum battery current; and
determining a discharge limit current, the limiting battery current being defined as the lesser of the maximum battery current and the discharge limit current.

3. The method of claim 2, wherein the limiting battery current is the maximum battery current, and the limiting battery voltage is a minimum battery voltage, the power capability of the battery being a discharge power capability defined as the maximum battery current times the minimum battery voltage.

4. The method of claim 2, further comprising:
setting the battery current equal to the discharge limit current; and
calculating a discharge voltage for the battery from the at least one governing equation, and
wherein the limiting battery current is the discharge limit current, the limiting battery voltage is the discharge voltage, and the power capability of the battery is defined as the discharge limit current times the discharge voltage.

5. The method of claim 1, further comprising:
determining a minimum battery current; and
determining a charge limit current, the limiting battery current being defined as the greater of the minimum battery current and the charge limit current.

6. The method of claim 5, wherein the limiting battery current is the minimum battery current, and the limiting battery voltage is a maximum battery voltage, the power capability of the battery being a charge power capability defined as the minimum battery current times the maximum battery voltage.

7. The method of claim 5, further comprising:
setting the battery current equal to the charge limit current; and
calculating a charge voltage for the battery from the at least one governing equation, and
wherein the limiting battery current is the charge limit current, the limiting battery voltage is the charge voltage, and the power capability of the battery is defined as the charge limit current times the charge voltage.

8. The method of claim 1, wherein the at least one governing equation includes a pair of equations defined as:
$$\begin{matrix}{\dot{v}}_{2} = - \frac{1}{{r}_{2} c} {v}_{2} + \frac{1}{c} i \\ {v}_{oc} - v = {v}_{2} + {ir}_{1}\end{matrix}$$
where:
v is a determined battery voltage,
v₂ is a voltage from the circuit model,
$${\dot{v}}_{2} = \frac{d {v}_{2}}{d t}$$
and is the time based differential of v₂,
v_{oc} is the open circuit voltage of the battery,
i is the battery current, and
r₁, r₂, c are two resistance values and a capacitance value, respectively, from the circuit model.

9. The method of claim 8, wherein the battery current is solved-for from Eq. 1 and Eq. 2 as:
$$i = \frac{( {v}_{oc} - v - {v}_{2} ( 0 ) {e}^{- {t}_{d} / ( {r}_{2} c )} )}{[ {r}_{1} + {r}_{2} ( 1 - {e}^{- {t}_{d} / ( {r}_{2} c )} ) ]}$$
where:
t_{d} is a predetermined time value,
v₂ (0) is the present value of v₂, and
e is the base of the natural logarithm.

10. A method for determining a power capability for a battery, comprising:
generating at least one equation for a circuit model for the battery;
defining a battery current from the at least one equation;
determining a limiting battery current based at least in part on the defined battery current;
determining a limiting battery voltage; and
determining the power capability of the battery based on the limiting battery current and the limiting battery voltage.

11. The method of claim 10, further comprising:
determining a maximum value for the battery current; and
determining a discharge limit current, the limiting battery current being defined as the lesser of the maximum value for the battery current and the discharge limit current.

12. The method of claim 11, wherein the limiting battery current is the maximum value for the battery current, and the limiting battery voltage is a minimum value for the battery voltage, the power capability of the battery being a discharge power capability defined as the maximum value for the battery current times the minimum value for the battery voltage.

13. The method of claim 11, further comprising calculating a discharge voltage for the battery from the at least one equation using the discharge limit current for the battery current, and
wherein the limiting battery current is the discharge limit current, the limiting battery voltage is the discharge voltage, and the power capability of the battery is defined as the discharge limit current times the discharge voltage.

14. The method of claim 10, further comprising:
determining a minimum value for the battery current; and
determining a charge limit current, the limiting battery current being defined as the greater of the minimum value for the battery current and the charge limit current.

15. The method of claim 14, wherein the limiting battery current is the minimum value for the battery current, and the limiting battery voltage is a maximum value for the battery voltage, the power capability of the battery being a charge power capability defined as the minimum value for the battery current times the maximum value for the battery voltage.

16. The method of claim 14, further comprising calculating a charge voltage for the battery from the at least one equation using the charge limit current as the battery current, and
wherein the limiting battery current is the charge limit current, the limiting battery voltage is the charge voltage, and the power capability of the battery is defined as the charge limit current times the charge voltage.

17. A method for determining a power capability for a battery, comprising:
defining at least one equation based on a circuit model for the behavior of the battery, the equation including a plurality of battery parameters, including a battery current;
measuring the value of at least one of the battery parameters;
solving for the battery current from the at least one equation;
defining a limiting battery current based at least in part on the battery current;
determining a limiting battery voltage; and
determining the power capability of the battery based on the limiting battery current and the limiting battery voltage.

18. The method of claim 17, wherein the step of measuring the value of at least one of the battery parameters includes measuring an open circuit voltage of the battery.

19. The method of claim 17, further comprising defining a maximum value for the battery current, the limiting battery current being defined as the lesser of the maximum value for the battery current and a predetermined discharge limit current.

20. The method of claim 17, further comprising defining a minimum value for the battery current, the limiting battery current being defined as the greater of the minimum value for the battery current and a predetermined charge limit current.
